(19) United States
(12) Patent Application Publication
(10) Pub. No.: US 2012/0227668 A1
(43) Pub. Date: Sep. 13, 2012

(54) AUTOMATIC ANIMAL FEEDING SYSTEM

(76) Inventor: Marjorie Aycock, Sadieville, KY (US)

(21) Appl. No.: 13/414,693

(22) Filed: Mar. 7, 2012

Related U.S. Application Data
(60) Provisional application No. 61/450,004, filed on Mar. 7, 2011.

(51) Int. Cl. A01K 5/02

(52) U.S. Cl. 119/51.02

(57) ABSTRACT

A covered feeding or watering bowl for animals that uncovers for the animal for which the food or water is intended through the use of an authentication process which verifies the identity of an animal by a signal transmitted from a transmitter integrated into or onto the animal's collar when the transmitter is within the nominal range for the receiver, and a short-range proximity detector to validate that the animal is in front of the bowl in a feeding position.

### CROSS REFERENCE TO RELATED APPLICATIONS

This application claims the benefit of U.S. Provisional Patent Application No. 61/480,125 filed Mar. 7, 2011.

### TECHNICAL FIELD

The present invention relates to automatic animal feeding systems, and more particularly, to a controlled automatic animal feeding system keyed to a signal emitted from a pet tag.

### BACKGROUND

Various types of automatic animal feeding systems are known in the prior art. However, what is needed is a radio-frequency controlled automatic animal feeding system which includes a pet dish having base member with at least one cavity therein for containing food, dfl access lid disposed atop each cavity, a radio-frequency receiver disposed on the base member that is in operational communication with a rotating mechanism that selectively rotates the access lid, and a corresponding radio-frequency transmitter disposed on an animal collar. The radio-frequency receiver is selectively activated by the radio-frequency transmitter upon the detection of a unique radio-frequency, wherein the receiver operationally engages a rotating mechanism disposed in the base member which, in turn, pivots the access lid from a closed condition to an open condition giving the animal bearing the transmitter access to food contained in the dish.

### SUMMARY

The general purpose of the present automatic animal feeding system, described subsequently in greater detail, is to provide an automatic animal feeding system which has many novel features that result in an automatic animal feeding system which is not anticipated, rendered obvious, suggested or even implied by prior art, either alone or in combination thereof.

To accomplish this, the present automatic animal feeding system is designed to prevent other animals from accessing food in each other's dishes by each pet having a radio-frequency receiver disposed a collar tag which corresponds to a specific transmitter disposed on a pet dish. This allows a user to allocate a specific food to a specific animal, which assists when a specific animal has special diet requirements. In addition, the present animal feeding system prevents one of several pets from eating the other pets' food, thus keeping the one pet from overeating and becoming obese, while allowing the other pets' to eat a proper amount of food.

The device includes a base member having at least one cavity therein for receiving pet food or alternately, water, therein. The present device also includes a hollow hemispherical access lid that entirely covers the cavity. The access lid has two halves having a continuous internal edge, the internal edge pivotally attached to a pivot point disposed on each side of the cavity. The pivot point is in operational communication with a rotating mechanism disposed within the base. The rotating mechanism is in operational communication with a power source disposed within the base member. The access lid is configured to separate along the internal edge of each half of the access lid. The access lid may be transparent to permit a quick viewing of the contents contained within the cavity to determine if a refill of the contents is required. The device further includes a radio-frequency receiver disposed on the base member and a radio-frequency transmitter on a collar tag. The radio-frequency receiver, i.e. radio-frequency detector, is selectively activated by the radio-frequency transmitter upon the detection of a radio-frequency unique to both the transmitter and the receiver, wherein the receiver engages the rotating mechanism which, in turn, pivots the access lid halves to change the access lid from a closed condition to an open condition thereby permitting the animal bearing the transmitter on its collar tag access to the contents, such as food or water, of the base member cavity. Moreover, the device further includes a passive infrared detector to sense the physical presence of an animal in front of the device which acts in conjunction with the radio-frequency receiver to ensure that the target animal is within the nominal range of the device and is most likely positioned in front of the device prior to actuating the rotating mechanism.

One object of the disclosed device is to provide an automatic animal feeding system which may be easily and efficiently manufactured and marketed.

Another object of the disclosed device is to provide a new automatic animal feeding system which is of a durable and reliable construction.

Still another object of the disclosed device is to provide a new automatic animal feeding system which is susceptible of a low cost of manufacture with regard to both materials and labor, and which accordingly is then susceptible of low prices of sale to the consuming public, thereby making such automatic animal feeding system economically available to the buying public.

Even another object of the disclosed device is to provide an automatic animal feeding system which provides in the apparatuses and methods of the prior art some of the advantages thereof, while simultaneously overcoming some of the disadvantages normally associated therewith.

Still yet another object of the disclosed device is to provide a new automatic animal feeding system for automatically providing an animal with a specific supply of food, while eliminating access to the supply of food by other animals.

Yet another object of the disclosed device is to provide a new automatic animal feeding system which includes a base member having at least one cavity therein, a hemispherical access lid separated into two halves, a rotating mechanism which rotates the access lid haves to permit access to the cavity, and a radio-frequency transmitter selectively activated by a radio-frequency receiver disposed on the collar tag wherein upon the detection of a radio-frequency unique to both the transmitter and the receiver, and further wherein the rotating mechanism is activated and pivots the access lid halves to change the access lid from a closed condition to an open condition.

Still yet another object of the disclosed device is to provide a new automatic animal feeding system that allows the user to serve a specific diet to one pet without other animals consuming the food.

Even still another object of the disclosed device is to provide a new automatic animal feeding system that protects the an animal's food from contamination and debris.

Still another object of the disclosed device is to provide an automatic feeding system which automatically allows a specified animal to open the access lid to a specified bowl.

A further objective of the present invention is to provide an animal with his food while keeping children away and out of the specified food.

Thus has been broadly outlined the more important features of the present automatic animal feeding system and method so that the detailed description thereof that follows may be better understood and in order that the present contribution to the art may be better appreciated.

Numerous objects, features and advantages of the present automatic animal feeding system will be readily apparent to those of ordinary skill in the art upon reading the following detailed description of presently preferred, but nonetheless illustrative examples of the present automatic animal feeding system and method when taken in conjunction with the accompanying drawings. In this respect, before explaining the current examples of the present automatic animal feeding system and method in detail, it is to be understood that the invention is not limited in its application to the details of construction and arrangements of the components set forth in the following description or illustration. The invention is capable of other examples and of being practiced and carried out in various ways. It is also to be understood that the phraseology and terminology employed herein are for purposes of description and should not be regarded as limiting as the applicant may act as her own lexicographer.

Those skilled in the art will appreciate that the conception upon which this disclosure is based may readily be utilized as a basis for the design of other structures, methods and systems for carrying out the several purposes of the automatic animal feeding system and method. It is therefore important that the claims be understood as including such equivalent constructions insofar as they do not depart from the spirit and scope of the present invention.

Objects of the disclosed automatic animal feeding system and method, along with various novel features that characterize the invention are particularly pointed out in the claims forming a part of this disclosure. A better understanding of the automatic animal feeding system and method of operation, its operating advantages and specific objects attained by its uses, can obtained through the accompanying drawings and description.

### BRIEF DESCRIPTION OF THE DRAWINGS

FIG. 1 is a perspective view of an embodiment of the disclosed device with an access lid in the closed position.

FIG. 2 is a cross-sectional view of an embodiment of the disclosed device with an access lid in the closed position.

FIG. 3 is a perspective view of an embodiment of the disclosed device with the access lid removed.

FIG. 4 is a perspective view of an embodiment of the access lid of the disclosed device.

FIG. 5 is a perspective view of an embodiment of the base cover of the disclosed device.

FIG. 6 is a perspective view of an embodiment of the food receptacle of the disclosed device.

FIG. 7 is a perspective view of an embodiment of the food receptacle housing of the disclosed device.

FIG. 8 is a perspective view of an embodiment of the control tag which operates the access lid base of the disclosed device.

FIG. 9 is a schematic diagram of the operation of the system.

FIG. 10 is a representation of the two condition actuation method of the operation of the system.

### DETAILED DESCRIPTION OF THE DRAWINGS

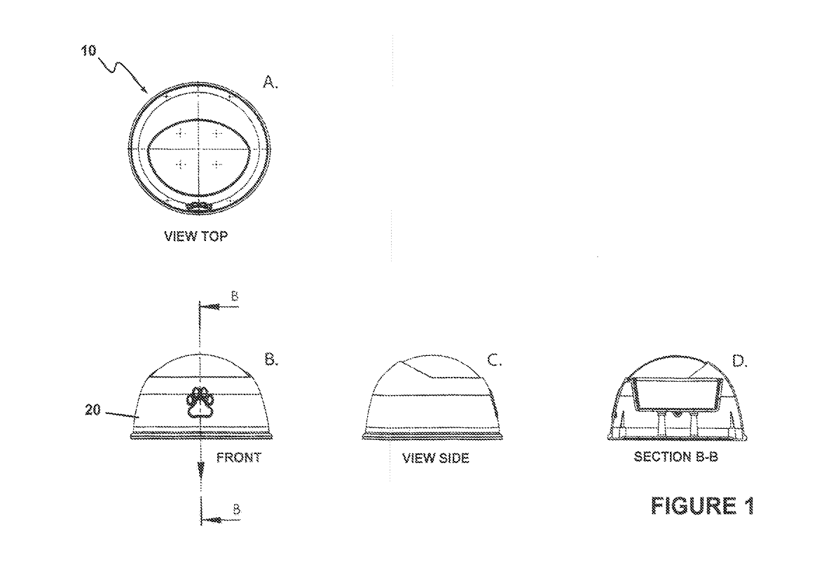

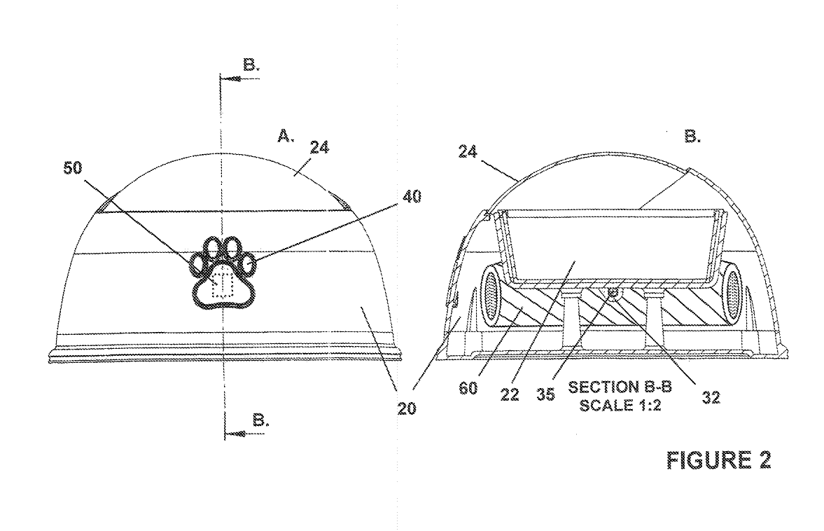

With reference now to the drawings, and in particular FIGS. 1 and 2, an example of the instant automatic animal feeding system employing the principles and concepts of the present automatic animal feeding system and generally designated by the reference number 10 will be described.

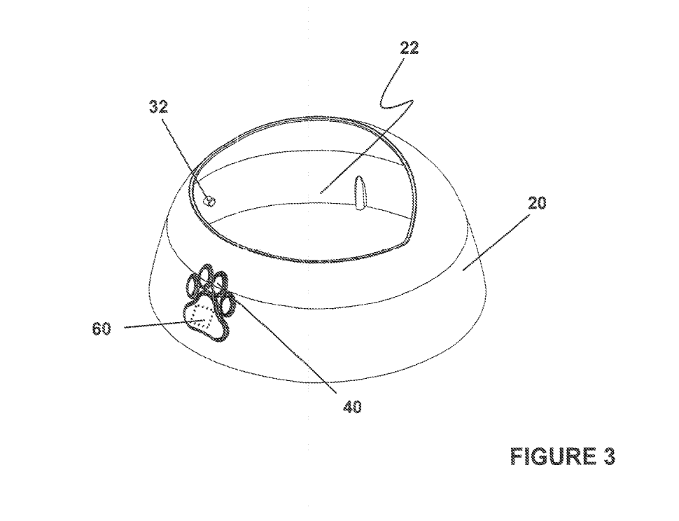

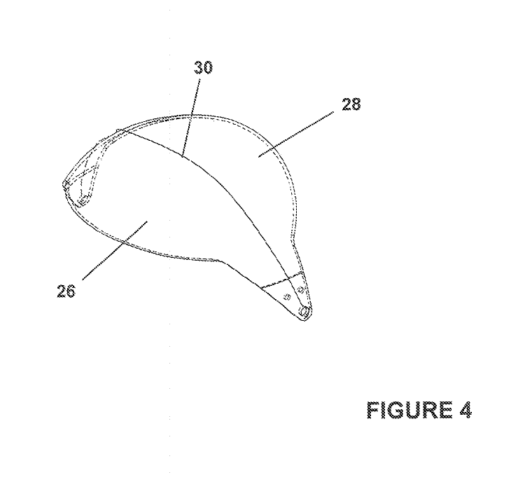

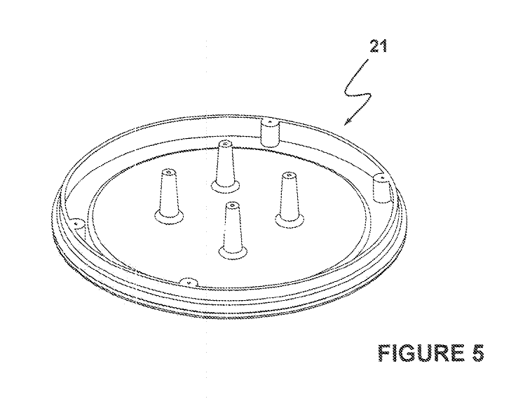

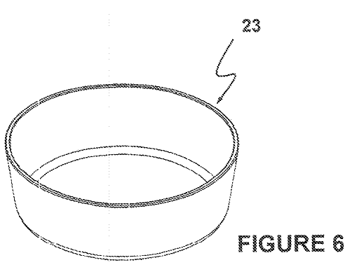

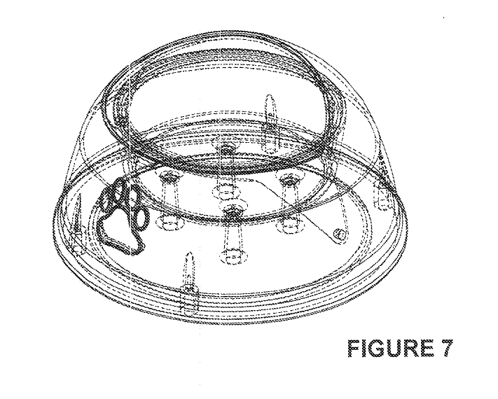

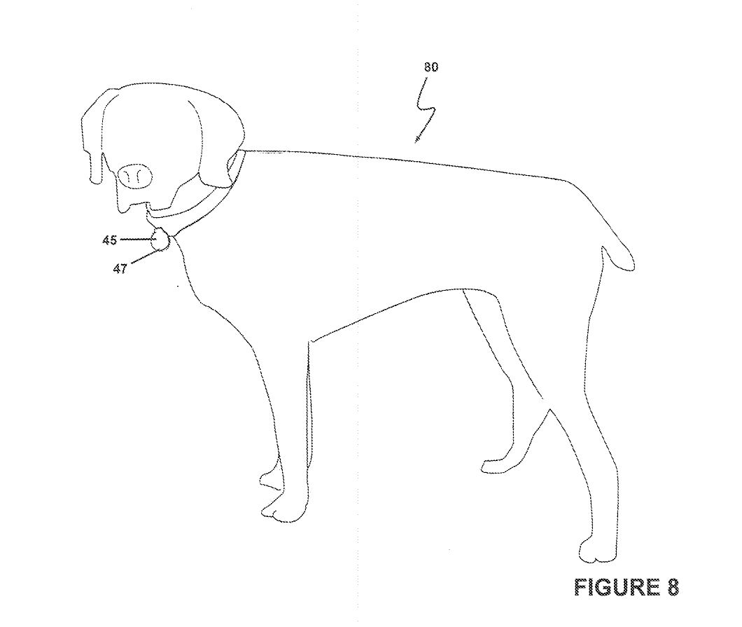

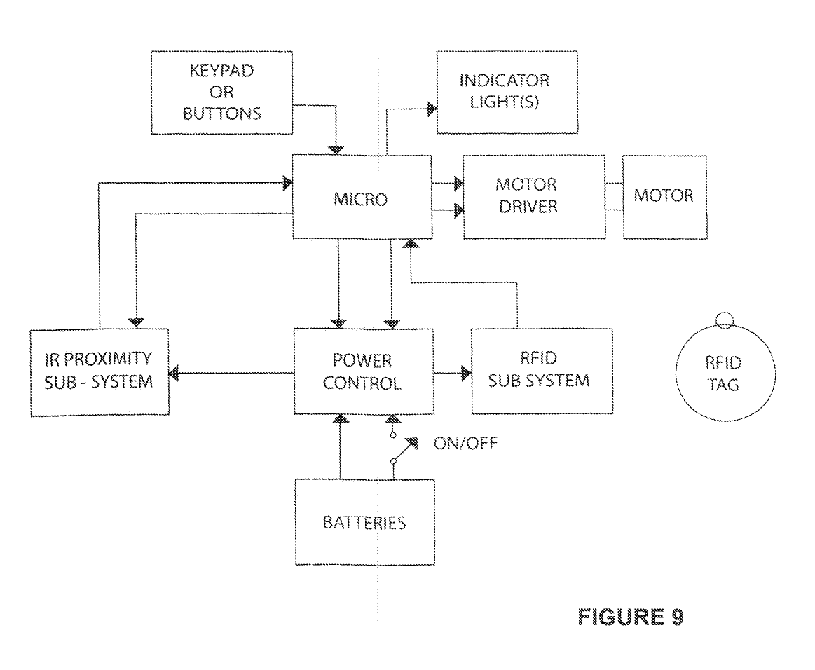

Referring to FIGS. 1 through 10, a preferred embodiment of the present automatic animal feeding system 10 is illustrated. The automatic animal feeding system 10 provides a base member 20 having a base cover 21. The base member 20 has at least one cavity 22 centrally disposed therein to receive a food receptacle 23. A hollow hemispherical lid 24 is disposed on each cavity 22 and is configured to cover the entire cavity 22. In an embodiment of the access lid 24, the access lid 24 has two halves 26, 28 but may also be configured as a single construct in other various embodiments of the access lid 24. Each half 26, 28 has a continuous internal edge 30. The internal edge 30 is pivotally attached to a pivot point 32 disposed on each side of the cavity 22. The pivot point 32 is in operational communication with a rotating mechanism 35 disposed within the base member 20. The rotating mechanism 35 is in operational communication with a power source disposed within the base member 20. The access lid 24 is configured to separate along the internal edge 30 of each half 26, 28 of the access lid 24. The access lid 24 may be transparent to permit a quick viewing of the contents contained within each cavity 22 to determine if a refill of the contents is required. The device 10 further includes a radio-frequency receiver 40 disposed about the base member 20 and a mated, battery-operated radio-frequency transmitter 45 disposed on a pet collar tag 47. The radio-frequency receiver 40 is selectively activated by the radio-frequency transmitter 45 upon the detection by the radio-frequency receiver 40 of a radio-frequency signal from the transmitter 45 configured to emit a signal which, by frequency or other configurable radio signal characteristic, is recognized as a key the receiver 45, wherein the receiver 45 signals a control mechanism which operationally engages the rotating mechanism 35 which, in turn, pivots the access lid 24 or access lid 24 halves 26, 28 to modify the access lid 24 position from a closed condition to an open condition thereby permitting access to the contents contained within the base member 20 cavity to the animal 80 bearing the radio-frequency transmitter 45 on the animal's collar tag 47.

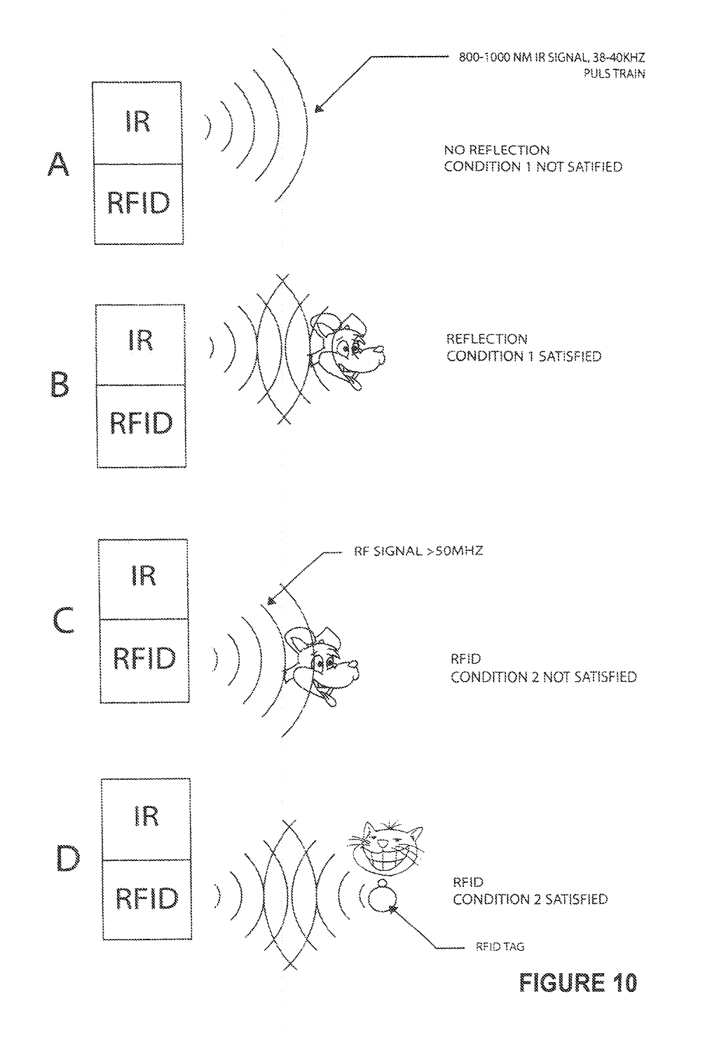

In a preferred embodiment as depicted in FIG. 10, the device 10 utilizes a short-range, directional proximity detector, e.g. an infrared transceiver or a passive infrared proximity detector 50 (a “PID”) to detect the presence of an animal in front of the feeding station. The short-range, directional proximity detector 50 works in combination with the radio-frequency detector 40 to ensure that the target animal is not only within the effective range of the device 10, i.e. the nominal range, but that a physical presence is also detected in the feeding position so as to minimize the engagement of the rotating mechanism 35 of the device 10 when the intended animal 80 fails to demonstrate an interest in eating or drinking and does not approach locate itself in front of the station 10 where the short-range directional proximity detector 10 is actively sensing.

The rotating mechanism 35 is driven by a motor housed within the base member 20 and controlled by a control system reacting to a positive response from the short-range, directional proximity detector 50 and the radio-frequency detector 40.

In the short-range, directional proximity detector 50, the sensor is preferably mounted on a printed circuit board containing the components required to interpret the signals from the sensor's chip. The complete assembly is preferably affixed to the base member 20 by mounting it at the front of the device 10 and behind a detector window 57 which is substantially transparent to infrared radiation.

In a further embodiment, the device 10 may be configured with a cooling means 60 to cool the food or water. Non-limiting examples of cooling means 60 include refrigerated or frozen gel packs and ice received into the base member 20.

While particular automated feeding systems have been shown and described herein as preferred embodiments, it will be readily apparent that various changes and modifications could be made therein without departing from the spirit and scope of the invention as defined in the following claims.

What is claimed is:

1. An automated feeding station comprising a base member, said base member having a base and walls rising substantially vertically therefrom to form a cavity capable of receiving food therein; an articulating lid; a means for articulating said lid between open and closed positions; a radio-frequency receiver; a radio-frequency transmitter to be worn by target animal; a physical proximity detector; a signal processing means; and a control system for causing said means for articulating said lid to move said lid from a closed to an open position in response to a signal from said physical proximity detector and said radio-frequency detector.

2. The device of claim 1, wherein said lid rotates about fixed pivot points which function to retain said lid and guide said articulation along a substantially arcuate path so as to achieve substantially complete closure and opening to permit access to said cavity.

3. The device of claim 2, wherein said lid is comprised of two members which articulate in opposing directions.

4. The device of claim 1, wherein said cavity is configured to receive a feeding bowl.

5. The device of claim 1, wherein said physical proximity detector is capable of detecting the proximity of an animal in front said device.

6. The device of claim 5, wherein said physical proximity detector utilizes a passive infrared detector and responds to reflections of infrared energy.

7. The device of claim 1, wherein said radio-frequency detector responds to an RFID tag mated to said device.

8. The device of claim 1, wherein said signal processing means selected from the group consisting of is a microprocessor, PIC, microcontroller, computer processor or similar means to process instructions written in machine readable code.

9. The device of claim 1, wherein said signal processing means generates a signal to cause the articulation of said lid in response to affirmative responses from said radio-frequency detector and said physical proximity detector.

10. The device of claim 1, wherein said base member is configured to receive a cooling means.

11. The method of controlling access to a sealed animal feeding station comprising the mechanical unsealing of said station by said station's receipt of an expected transmission of a unique signal by an animal worn signal transmitter which is detected by a signal receiver which is configured to only respond to said unique signal, and the sensing of the physical presence of an animal in front of said station by a short-range, directional proximity detector.

12. The method of claim 11, wherein said short-range, directional proximity detector is a passive infrared detector.

13. The method of claim 11, wherein said animal worn signal transmitter is joined to a wearable tag.

14. The method of claim 11, wherein said signal receiver and said animal worn signal transmitter are available in a plurality of paired said animal worn signal transmitters and station associated receivers so as to allow the use of a plurality of said stations among a plurality of said animals so as to ensure that only an intended said animal can access its intended said station.

15. The method of claim 14, wherein said signal is a radio-frequency signal.
